(19) United States
(12) Patent Application Publication
(10) Pub. No.: US 2026/0271000 A1
(43) Pub. Date: Sep. 10, 2026

(54) PHYSICAL UPLINK CONTROL CHANNEL TRANSMISSION USING BEST-EFFORT COHERENT MULTIPLE-INPUT MULTIPLE-OUTPUT

(71) Applicant: QUALCOMM Incorporated, San Diego, CA (US)

(72) Inventors: Kangqi LIU, San Diego, CA (US); Hyojin LEE, San Diego, CA (US); Weimin DUAN, San Diego, CA (US)

(21) Appl. No.: 19/071,691

(22) Filed: Mar. 5, 2025

(51) Int. Cl. H04W 72/21; H04B 7/0456; H04L 5/00

(52) U.S. Cl. CPC H04W 72/21; H04B 7/0456; H04L 5/0051

(57) ABSTRACT

Certain aspects of the present disclosure provide techniques for wireless communications. An example method includes transmitting an indication of one or more coherent durations relative to a sounding reference signal (SRS) transmission; selecting a precoding operation to be applied to a physical uplink control channel (PUCCH) communication, wherein the precoding operation is selected based at least in part on a timing of the PUCCH communication relative to the one or more coherent durations; and transmitting the PUCCH communication based at least in part on the selected precoding operation.

### INTRODUCTION

### Field of the Disclosure

Aspects of the present disclosure relate to wireless communications, and more particularly, to techniques for physical uplink control channel (PUCCH) transmission using best-effort coherent multiple-input multiple-output (MIMO).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communications by a user equipment (UE). The method includes transmitting an indication of one or more coherent durations relative to a sounding reference signal (SRS) transmission; selecting a precoding operation to be applied to a physical uplink control channel (PUCCH) communication, wherein the precoding operation is selected based at least in part on a timing of the PUCCH communication relative to the one or more coherent durations; and transmitting the PUCCH communication based at least in part on the selected precoding operation.

Certain aspects provide a method of wireless communications by a UE. The method includes selecting a precoding operation to be applied to an uplink communication, wherein the precoding operation is selected based at least in part on a coherency state of the UE at a time associated with the uplink communication; transmitting coherency information including information associated with the precoding operation; and transmitting the uplink communication according to the precoding operation.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for communications in a network between a UE and a network entity.

FIGS. 6-7 depict examples associated with PUCCH transmission using best-effort coherent MIMO according to the techniques and apparatuses depicted and described with respect to FIG. 5.

FIG. 8 depicts a process flow for communications in a network between a UE and a network entity.

FIG. 9 depicts an example associated with PUCCH transmission using best-effort coherent MIMO according to the techniques and apparatuses depicted and described with respect to FIG. 8.

FIG. 10 depicts a method for wireless communications.

FIG. 11 depicts aspects of an example communications device.

FIG. 12 depicts another method for wireless communications.

FIG. 13 depicts aspects of an example communications device.

### DETAILED DESCRIPTION

Aspects of the present disclosure provide apparatuses, methods, processing systems, and computer-readable mediums for PUCCH transmission using best-effort coherent MIMO.

In some wireless communications systems, a physical uplink control channel (PUCCH) transmission can be transmitted according to a non-coherent cyclic delay diversity (CDD) scheme. CDD is a transmit diversity scheme that can be used to introduce cyclic delays (i.e., phase shifts) among transmit antennas of a transmitter wireless communication device. These cyclic delays create frequency-selective fading effects, which can improve frequency diversity. Non-coherent CDD refers to CDD in which multiple, differently delayed versions of a signal are transmitted by transmit antennas of a transmitter wireless communication device, and a receiver wireless communication device processes these signals without knowledge of phase alignment between the differently delayed versions of the signal. In general, non-coherent CDD leverages power diversity provided by the differently delayed signals (rather than relying on precise phase coherence). Non-coherent CDD can be implemented to, for example, avoid random phase superposition between wireless channels (e.g., to avoid destructive interference). However, non-coherent CDD can degrade performance when applied to some PUCCH transmissions. For example, for some PUCCH formats (e.g., format 0, format 1, or format 4), in a single a resource block (RB), a phase rotation caused by a ⅓ cyclic prefix (CP) cyclic timing shift is approximately 100 degrees. In many scenarios, single-RB scheduling is used for PUCCH transmissions, and the ⅓ CP CDD is introduced to avoid reverse superposition. In theory, when considering a full range of possible phase differences between two antennas ports (e.g., −180 degrees to 180 degrees), there is a ⅓ probability that the use of CDD results in a negative power gain when using two antennas for a CDD PUCCH transmission (e.g., as compared to using a single antenna). That is, there is a one-in-three chance that the use of non-coherent CDD for a single-RB PUCCH transmission at two antennas will cause negative power gain, meaning that reliability with respect to the PUCCH transmission is reduced. Thus, non-coherent CDD PUCCH may not be suitable for transmitting single-RB PUCCH transmissions using multiple UE transmit antennas.

Some wireless communications systems support both fully-coherent (FC) precoding and non-coherent (NC) precoding. NC precoding is, in practice, equivalent to antenna port selection that does not provide any coherent combining gain of signals transmitted at different antenna ports. Conversely, FC precoding aims to maximize a coherent combining gain from signals transmitted at different antenna ports. In practice, a network entity may configure or schedule NC precoding or FC precoding for a transmission by a UE depending on a UE capability (e.g., whether capability information provided by the UE indicates that the UE supports FC precoding). In practice, FC precoding has not been widely deployed in wireless communications systems due to the associated implementation complexity and lack of support in wireless communications standards.

Further, in some wireless communications systems, PUCCH transmissions are as single-port transmissions (e.g., according to applicable wireless communications standards). From an implementation perspective, a UE can use one antenna to transmit a PUCCH transmission or can use multiple antennas to transmit the PUCCH communication. However, if the UE uses multiple antennas to transmit the PUCCH transmission, then a network entity receiving the PUCCH transmission sees only one antenna port (e.g., the number of antennas used by the UE for the PUCCH transmission is transparent to the network entity). Therefore, multi-port PUCCH transmissions could improve reliability with respect to PUCCH transmissions (e.g., for coverage enhancement scenarios, such as a UE at a cell edge), and may therefore be beneficial if implemented in a wireless communications system.

One technique for implementing multi-port PUCCH transmissions is a coherent uplink multiple-input multiple-output (MIMO) scheme. In general, coherent uplink MIMO enables a UE (with multiple transmit antennas) to transmit signals to a network entity (with multiple receive antennas) in a phase-aligned manner. One important feature with respect to coherent uplink MIMO is that relative phase across transmit antennas of the UE needs to be maintained from a time associated with channel sounding (e.g., a time of a sounding reference signal (SRS) transmission) to a time of an uplink transmission. One challenge with respect to coherent uplink MIMO is that a likelihood of wireless channel decorrelation increases as a periodicity associated with channel sounding increases (e.g., as SRS periodicity increases), which can reduce efficiency of coherent uplink MIMO. Another challenge with respect to coherent uplink MIMO is that phase changes at transmit antennas of the UE can occur as a result of a radio frequency (RF) control update event at the UE, such as an uplink/downlink switching event, a power adaptation event, or an antenna switching event, among other examples. Notably, disabling RF control update events at a UE (e.g., to maintain phase coherency for the purpose of coherent uplink MIMO) is challenging and can negatively impact other functionality of the UE and, therefore, is not desirable.

One approach to providing support for coherent uplink MIMO is based on UE hardware implementation. For example, a UE may implement a feature for quickly returning one or more transmit antennas to a reference phase (or power) state after an RF control update event. However, this approach requires additional computational cost and complexity at the UE (e.g., to detect a phase/power change and provide compensation) and, therefore, is not desirable.

Another approach to providing support for coherent uplink MIMO is network-entity-assisted over-the-air (OTA) calibration. According to this approach, a UE transmits an SRS for calibration, and a network entity provides calibration parameters based on a measurement of the SRS. However, fading effects and RF phase/power change effects are not easily distinguishable based on an SRS measurement, meaning that calibration based on SRS measurements may not be reliable. Further, this approach introduces latency due to the time needed to perform the SRS measurement at the network entity, compute calibration parameters at the network entity, transmit the calibration parameters to the UE, and apply the calibration parameters at the UE.

Still another approach to providing support for coherent uplink MIMO is best-effort coherent MIMO. According to this approach, a UE and/or a network entity tracks an uplink MIMO coherency status of the UE. Based on this tracking, coherent precoding (e.g., FC precoding or partially coherent precoding) can be applied when capable, while non-coherent precoding is applied otherwise. As described in further detail below, aspects described herein may serve to enable implementation of a best-effort coherent MIMO scheme based on restrictions at the UE, coherency reporting by the UE, and/or network entity signaling. In some aspects, the techniques and apparatuses enable coherent MIMO to be implemented such that at least a portion of one or more PUCCH occasions can achieve coherent combining gain, without significantly increasing complexity at the UE and without a need for latency-inducing calibration of the UE.

Increasing or maximizing PUCCH reliability is desirable in to improve performance of a wireless communications system. As noted above, the use of multi-port PUCCH transmissions can improve PUCCH reliability, and one technique for implementing multi-port PUCCH transmissions is coherent uplink MIMO. However, technical problems for implementation of coherent uplink MIMO may include, for example, cost and complexity at the UE (e.g., in the case of coherent MIMO implemented through UE hardware implementation) and increased latency (e.g., in the case of coherent MIMO implemented through network-entity-assisted OTA calibration).

Aspects described herein may overcome the aforementioned technical problem(s), for example, by enabling multi-port PUCCH transmissions using best-effort coherent MIMO. For example, in some aspects, a UE may transmit an indication of a coherent duration relative to an SRS transmission. The coherent duration is a time, after the SRS transmission, during which the UE can maintain coherency across transmit antennas of the UE. The UE may then select a precoding operation, to be applied to a PUCCH communication (e.g., a multi-port PUCCH transmission), based at least in part on a timing of the PUCCH communication relative to the coherent duration. The precoding operation may be, for example, fully coherent precoding, partially coherent precoding, or non-coherent precoding. In one example, if a PUCCH occasion associated with the PUCCH communication is within the coherent duration of the UE, then the UE selects the precoding operation as a fully coherent precoding. In another example, if the PUCCH occasion associated with the PUCCH communication is out of the coherent duration of the UE, then the UE selects the precoding operation as a non-coherent precoding. The UE then transmits the PUCCH communication based at least in part on the selected precoding operation.

Certain techniques for PUCCH transmission using best-effort coherent MIMO described herein may provide various beneficial technical effects and/or advantages. The techniques for PUCCH transmission using best-effort coherent MIMO may enable improved wireless communications performance, such as increased PUCCH reliability. The increased PUCCH reliability may be attributable to the techniques and apparatuses for best-effort coherent MIMO described herein, for example, due to the achievement of coherent combining gain for (at least a portion of) PUCCH occasions of some PUCCH transmissions (e.g., multi-port PUCCH transmissions). For example, the techniques and apparatuses enable a UE to apply fully coherent precoding when possible (e.g., within a coherent duration of the UE), meaning that coherent gain can be achieved for at least some PUCCH transmissions so as to increase PUCCH reliability. Of note, the techniques and apparatuses described herein provide this increased PUCCH reliability without increased cost or complexity at the UE and without increased latency.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

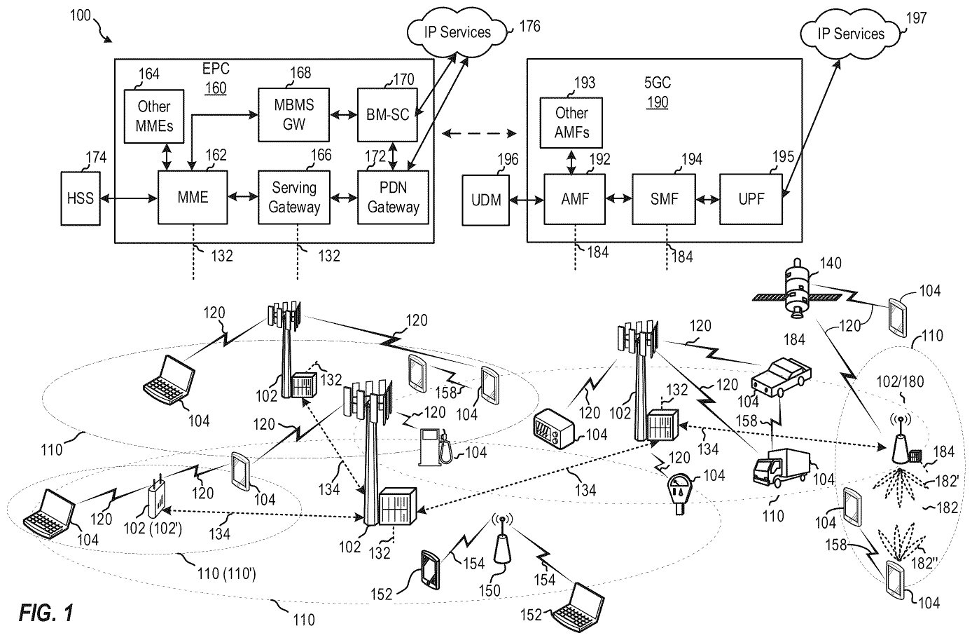

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

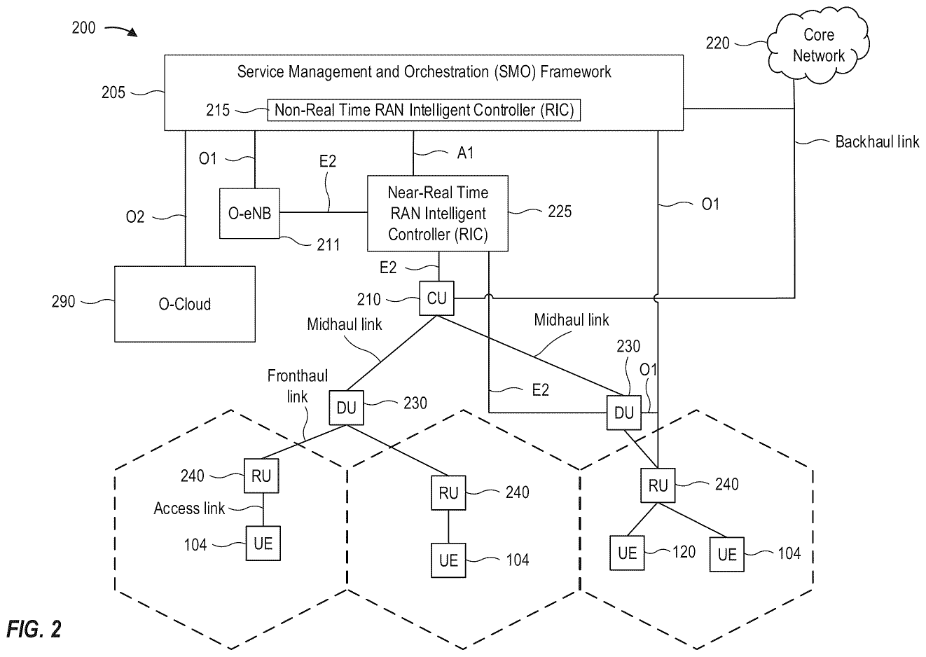

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

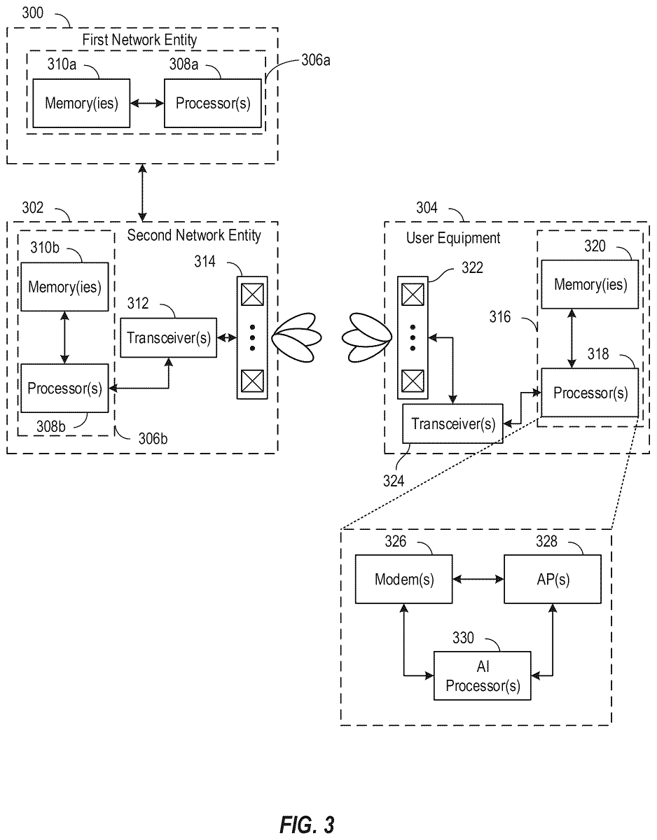

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

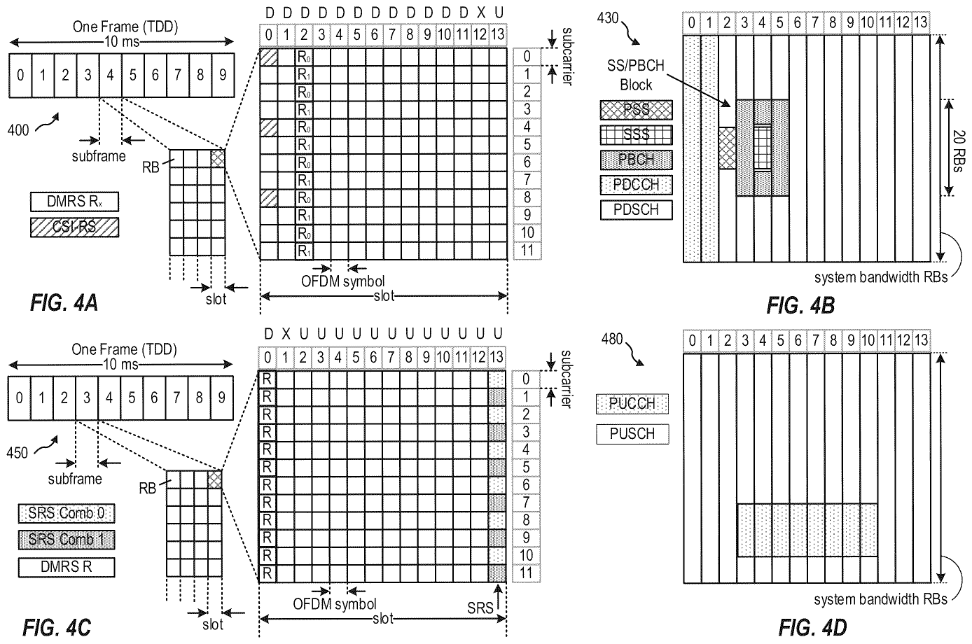

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Signaling Associated With Pucch Transmission Using Best-Effort Coherent MIMO

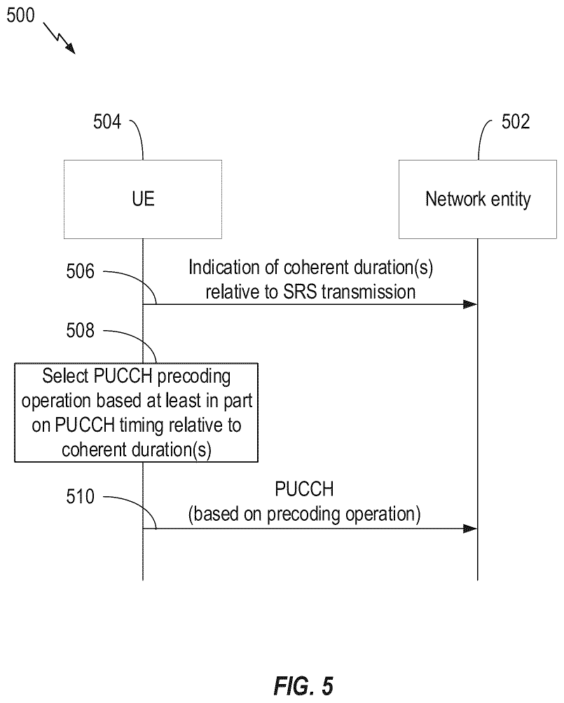

FIG. 5 depicts a process flow 500 for communications in a network between a network entity 502 and a user equipment (UE) 504. In some aspects, the network entity 502 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 504 may be an example of UE 104 depicted and described with respect to FIG. 1 or the UE 304 depicted and described with respect to FIG. 3. However, in other aspects, UE 504 may be another type of wireless communications device and network entity 502 may be another type of network entity or network node, such as those described herein. Note that any operations or signaling illustrated with dashed lines may indicate that that operation or signaling is an optional or alternative example.

At 506, the UE 504 transmits an indication of one or more coherent durations relative to an SRS transmission. A coherent duration is a time during which the UE 504 expects to maintain a particular coherency state with respect to transmit antennas of the UE 504. For example, a fully coherent duration may refer to a minimum amount of time during which the UE 504 expects to maintain a fully coherent state (e.g., a state in which a fixed phase relationship is maintained among all transmit antennas of the UE 504). As another example, a partially coherent duration may refer to a minimum amount of time during which the UE 504 expects to maintain a partially coherent state (e.g., a state in which phase correlation is maintained for at least some transmit antennas of the UE 504). In some aspects, the coherent duration is relative to an SRS transmission of the UE 504. For example, a fully coherent duration may be a minimum amount of time after an end of an SRS transmission that the UE 504 expects to maintain the fully coherent state. As another example, a partially coherent duration may be a minimum amount of time after an end of an SRS transmission that the UE 504 expects to maintain a partially coherent state. In some aspects, the coherent duration may be expressed in symbols, slots, milliseconds, or the like.

In some aspects, a given coherent duration of the one or more coherent durations may be associated with a particular quantity of antennas. For example, a first coherent duration of the one or more coherent durations may be associated with a first quantity of antennas (e.g., two antennas) and a second coherent duration of the one or more coherent durations may be associated with a second quantity of antennas (e.g., four antennas). Thus, in some aspects, the UE 504 may indicate one or more coherent durations for each of one or more quantities of antennas (e.g., a fully coherent duration for two antennas, a fully coherent duration for four antennas, a partially coherent duration for two antennas, a partially coherent duration for four antennas, or the like). In some aspects, a fully coherent duration associated with a given quantity of antennas may not be greater than a partially coherent duration associated with the given quantity of antennas (e.g., a fully coherent duration for four antennas may not be longer than a partially coherent duration for four antennas).

In some aspects, the indication transmitted by the UE 504 may indicate one or more coherent durations. For example, the indication may indicate a fully coherent duration associated with the UE 504 and may indicate a partially coherent duration associated with the UE 504. In some aspects, the UE 504 may transmit the indication in UE capability information provided to the network entity 502.

At 508, the UE 504 selects a precoding operation to be applied to a PUCCH communication. In some aspects, the UE 504 selects the precoding operation based at least in part on a timing of the PUCCH communication relative to the one or more coherent durations. For example, the UE 504 may select a precoding operation (e.g., fully coherent precoding, partially coherent precoding, or non-coherent precoding) to be applied to a PUCCH communication, with the precoding operation being selected based at least in part on whether the PUCCH communication is within a coherent duration indicated by the UE 504.

As one example, the UE 504 may determine that a PUCCH occasion associated with the PUCCH communication is within a fully coherent duration of the UE 504. That is, the UE 504 may determine that a PUCCH occasion in which the PUCCH communication is to be transmitted during the fully coherent duration of the UE 504. In this example, the UE 504 selects the precoding operation as a fully coherent precoding based at least in part on the PUCCH occasion being within the fully coherent duration.

As another example, the UE 504 may determine that the PUCCH occasion associated with the PUCCH communication is outside of a fully coherent duration of the UE 504 and within a partially coherent duration of the UE 504. That is the UE 504 may determine the PUCCH occasion in which the PUCCH communication is to be transmitted after the fully coherent duration of the UE 504, but during the partially coherent duration of the UE 504. In this example, the UE 504 selects the precoding operation as a partially coherent precoding based at least in part on the PUCCH occasion being outside of the fully coherent duration and within the partially coherent duration.

As another example, the UE 504 may determine that the PUCCH occasion associated with the PUCCH communication is outside of each of the one or more coherent durations of the UE 504. That is, the UE 504 may determine that the PUCCH occasion in which the PUCCH communication is to be transmitted is after all coherent durations of the UE 504 (e.g., after the fully coherent duration of the UE 504 and after the partially coherent duration of the UE 504). In this example, the UE 504 selects the precoding operation as a non-coherent precoding based at least in part on the PUCCH occasion being outside of the one or more coherent durations.

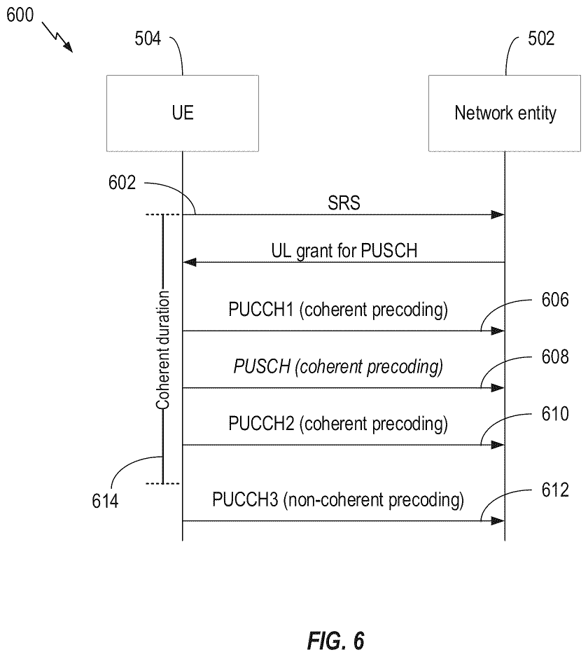

In some aspects, the UE 504 may select the precoding operation based at least in part on one or more parameters or characteristics associated with the PUCCH communication. For example, in some aspects, the UE 504 may select the precoding operation based at least in part on whether a frequency domain resource allocation of the PUCCH communication is included in a bandwidth of an SRS transmission (e.g., an SRS transmission relative to which the one or more coherent durations are measured). As another example, the UE 504 may in some aspects select the precoding operation based at least in part on whether the frequency domain resource allocation of the PUCCH communication is included in a bandwidth of a PUSCH communication (e.g., a coherent PUSCH communication scheduled via an uplink grant received by the UE 504) within the one or more coherent durations. As another example, the UE 504 may in some aspects select the precoding operation based at least in part on whether an amount of time between the uplink grant and the PUCCH occasion (e.g., a value of a k3 parameter, which indicates the amount of time between the uplink grant and the PUCCH occasion) satisfies (e.g., is greater than or equal to) a threshold. A particular example of selection of the precoding operation based at least in part on one or more parameters or characteristics associated with the PUCCH communication is described in further detail below with respect to FIG. 6.

At 510, the UE 504 transmits the PUCCH communication based at least in part on the selected precoding operation.

For example, if the precoding operation selected by the UE 504 is a fully coherent precoding, then, when transmitting the PUCCH communication, the UE 504 may perform the fully coherent precoding using a fully coherent precoder. In some aspects, the fully coherent precoder may be a precoder that maps the PUCCH communication to at least two antenna ports of the UE 504 (e.g., when the PUCCH communication is a multi-port PUCCH communication). In some such aspects, the fully coherent precoder may be indicated in an uplink grant, transmitted by the network entity 502 to the UE 504, that schedules a PUSCH communication within a fully coherent duration of the UE 504.

As another example, if the precoding operation selected by the UE 504 is a partially coherent precoding, then, when transmitting the PUCCH communication, the UE 504 may perform the partially coherent precoding using a partially coherent precoder. In some aspects, the partially coherent precoder may be a precoder that maps the PUCCH communication to at least two antenna ports of the UE 504 (e.g., when the PUCCH communication is a multi-port PUCCH communication). In some such aspects, the partially coherent precoder may be indicated to the UE 504 by the network entity 502. Additionally or alternatively, the UE 504 may in some aspects determine the partially coherent precoder based at least in part on a fully coherent precoder indicated to the UE 504 (e.g., a fully coherent precoder indicated in an uplink grant).

As another example, if the precoding operation selected by the UE 504 is a non-coherent precoding, then, when transmitting the PUCCH communication, the UE 504 may perform the non-coherent precoding using a non-coherent precoder. In some aspects, the non-coherent precoder may be a precoder that maps the PUCCH communication to at least two antenna ports of the UE 504 (e.g., when the PUCCH communication is a multi-port PUCCH communication). In some such aspects, the UE 504 may determine the non-coherent precoder (e.g., rather than the non-coherent being indicated by the network entity 502).

In some aspects, the PUCCH communication may be a sequence-based PUCCH transmission (i.e., DMRS-less PUCCH). In some such aspects, if the UE 504 performs coherent precoding (e.g., fully coherent precoding or partially coherent precoding), then transmitting the PUCCH communication may comprise using the coherent precoder to map a sequence to multiple antenna ports of the UE 504. Conversely, if the UE 504 performs non-coherent precoding, then transmitting the PUCCH communication may comprise using a non-coherent precoder to transmit a first sequence at a first antenna port and a second sequence at a second antenna port. Alternatively, if the UE 504 performs non-coherent precoding, then transmitting the PUCCH communication may comprise using a non-coherent precoder to transmit a sequence at a first antenna port and to transmit the sequence with a spatial division CDD at a second antenna port.

Alternatively, the PUCCH may in some aspects be another type of PUCCH communication (e.g., a DMRS-based PUCCH). In some such aspects, if the UE 504 performs coherent precoding (e.g., fully coherent precoding or partially coherent precoding), then transmitting the PUCCH communication may comprise using the coherent precoder to map a data layer to multiple antenna ports of the UE 504. Conversely, if the UE 504 performs non-coherent precoding, then transmitting the PUCCH communication may comprise using a non-coherent precoder to transmit a first data layer at a first antenna port and a second data layer at a second antenna port.

In some aspects, coherent precoding (e.g., fully coherent precoding or partially coherent duration precoding) may be enabled or disabled by the network entity 502. For example, the UE 504 may receive, from the network entity 502, an enablement indication that whether coherent precoding is enabled for PUCCH communications transmitted in PUCCH occasions that are within at least one of the one or more coherent durations. That is, the network entity 502 may indicate, to the UE 504, whether or not the UE 504 should apply coherent precoding for PUCCH communications for which PUCCH occasions are in the one or more coherent durations of the UE 504. In some aspects, the UE 504 may determine whether coherent precoding is enabled for the PUCCH communications, in accordance with the enablement indication, based at least in part on one or more PUCCH characteristics. That is, the UE 504 may in some aspects determine whether coherent precoding is enabled (or disabled) based at least in part on one or more PUCCH characteristics. The one or more PUCCH characteristics may include, for example, a format, a payload size, a symbol lasting length, a starting symbol index, a resource block (RB) allocation index (e.g., an index value indicating a set of allocated RBs), a starting RB index, or whether frequency hopping is enabled, among other examples.

Note that the process flow illustrated in FIG. 5 is an example of PUCCH transmission using best-effort MIMO, and aspects of the present disclosure may be applied to PUCCH transmission using best-effort MIMO. Note that the process flow illustrated in FIG. 5 is described herein to facilitate an understanding of PUCCH transmission using best-effort MIMO, and aspects of the present disclosure may be performed in various manners via alternative or additional signaling and/or operations. In certain aspects, the operations and/or signaling of FIG. 5 may occur in an order different from that described or depicted, and various actions, operations, and/or signaling may be added, omitted, or combined.

FIG. 6 depicts an example 600 associated with PUCCH transmission using best-effort coherent MIMO according to the techniques and apparatuses depicted and described with respect to FIG. 5. In this example, the UE 504 has indicated, to the network entity 502, a fully coherent duration associated with the UE 504. Further, in this example, the UE 504 is to transmit a first PUCCH communication (PUCCH1), a second PUCCH communication (PUCCH2) and a third PUCCH communication (PUCCH3) for reception by the network entity 502.

In the example 600, at reference 602, the UE 504 transmits an SRS transmission to the network entity 502. As shown, a coherent duration (e.g., a fully coherent duration) of the UE 504 is defined relative to the SRS transmission (e.g., such that the coherent duration starts at an end of the SRS transmission by the UE 504).

At reference 604, the network entity 502 transmits, to the UE 504, an uplink grant for a PUSCH communication. In this example, the uplink grant schedules the PUSCH communication for transmission within the fully coherent duration of the UE 504. In some aspects, the uplink grant may indicate a precoder (e.g., a fully coherent precoder) to be used for the PUSCH communication. In some aspects, the uplink grant may be communicated after the SRS transmission, as shown in the example 600. Alternatively, although not shown in FIG. 6, the uplink grant may in some aspects be communicated prior to the SRS transmission by the UE 504 (e.g., the network entity 502 may transmit the uplink grant to the UE 504 prior to the UE 504 transmitting the SRS).

With respect to the example 600, the UE 504 is configured to select a precoding operation for a given PUCCH communication as fully coherent precoding when a PUCCH occasion associated with the given PUCCH communication is within the fully coherent duration of the UE 504 and the UE 504 determines (1) that the frequency domain resource allocation of the PUCCH communication is included in the bandwidth of the SRS transmission, (2) the frequency domain resource allocation of the PUCCH communication is included in the bandwidth of the PUSCH communication scheduled within the fully coherent duration, and (3) an amount of time between the uplink grant and the PUCCH occasion satisfies a threshold. Thus, in this example, the network entity 502 may expect that a PUCCH communication be received at the network entity 502 within the fully coherent duration will be precoded using the same coherent precoder as the PUSCH transmission if (1) the frequency domain resource allocation of the PUCCH communication is included in the bandwidth of the SRS transmission, (2) the frequency domain resource allocation of the PUCCH communication is included in the bandwidth of the PUSCH communication that was indicated with the coherent precoding within coherent duration, and (3) the time interval between the uplink grant for the coherent PUSCH communication and the PUCCH occasion satisfies the threshold.

In this example, the PUSCH communication is scheduled within the fully coherent duration 614 of the UE 504. Further, the UE 504 determines that that the frequency domain resource allocation of the PUCCH communication is included in the bandwidth of the SRS transmission, (2) the frequency domain resource allocation of the PUCCH communication is included in the bandwidth of the PUSCH communication scheduled within the fully coherent duration, and (3) the amount of time between the uplink grant and the PUCCH occasion satisfies the threshold. Thus, as shown at reference 606, for the first PUCCH communication, which is to be transmitted in a PUCCH occasion that is within the fully coherent duration, the UE 504 selects the precoding operation as fully coherent precoding and transmits the first PUCCH communication accordingly (e.g., using the precoder that is to be used for the PUSCH communication, as indicated in the uplink grant).

At reference 608, the UE 504 transmits the PUSCH communication as scheduled by the uplink grant (e.g., using the precoder that is to be used for the PUSCH communication, as indicated in the uplink grant).

At reference 610, for the second PUCCH communication, which is to be transmitted in another PUCCH occasion that is within the fully coherent duration, the UE 504 selects the precoding operation as fully coherent precoding and transmits the second PUCCH communication accordingly (e.g., using the precoder that was used for the PUSCH communication, as indicated in the uplink grant).

At reference 612, for the third PUCCH communication, which is to be transmitted in a PUCCH occasion that is outside of the fully coherent duration, the UE 504 selects non-coherent precoding and transmits the third PUCCH communication accordingly (e.g., using a non-coherent precoder determined by the UE 504).

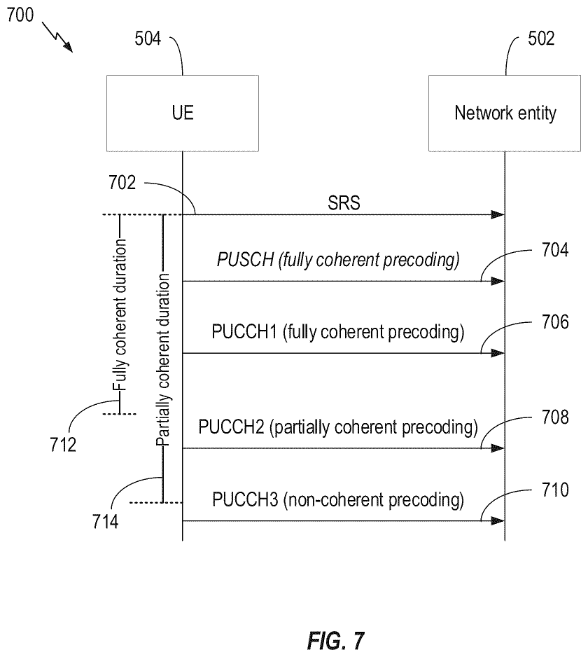

FIG. 7 depicts an example 700 associated with PUCCH transmission using best-effort coherent MIMO according to the techniques and apparatuses depicted and described with respect to FIG. 5. In this example, the UE 504 has indicated, to the network entity 502, a fully coherent duration 712 associated with the UE 504 and a partially coherent duration 714 associated with the UE 504. Further, in this example, the UE 504 is to transmit a first PUCCH communication (PUCCH1), a second PUCCH communication (PUCCH2) and a third PUCCH communication (PUCCH3) for reception by the network entity 502. Further, although not shown, the UE 504 has received an uplink grant scheduling a PUSCH communication within the fully coherent duration of the UE 504.

In the example 700, at reference 702, the UE 504 transmits an SRS transmission to the network entity 502. As shown, the fully coherent duration and the partially coherent duration of the UE 504 are defined relative to the SRS transmission (e.g., such that the fully coherent duration and the partially coherent duration start at an end of the SRS transmission by the UE 504).

At reference 704, the UE 504 transmits the PUSCH communication as scheduled by the uplink grant (e.g., using a fully coherent precoder indicated in the uplink grant).

At reference 706, for the first PUCCH communication (PUCCH 1), which is to be transmitted in a PUCCH occasion that is within the fully coherent duration, the UE 504 selects the precoding operation as fully coherent precoding and transmits the first PUCCH communication accordingly (e.g., using the precoder that was used for the PUSCH communication, as indicated in the uplink grant).

At reference 708, for the second PUCCH communication (PUCCH 2), which is to be transmitted in a PUCCH occasion that is outside of the fully coherent duration but within the partially coherent duration of the UE 504, the UE 504 selects partially coherent precoding and transmits the second PUCCH communication accordingly (e.g., using a partially coherent precoder determined by or indicated to the UE 504).

At reference 710, for the third PUCCH communication (PUCCH 3), which is to be transmitted in a PUCCH occasion that is outside of the fully coherent duration and outside of the partially coherent duration of the UE 504, the UE 504 selects non-coherent precoding and transmits the third PUCCH communication accordingly (e.g., using a non-coherent precoder determined by the UE 504).

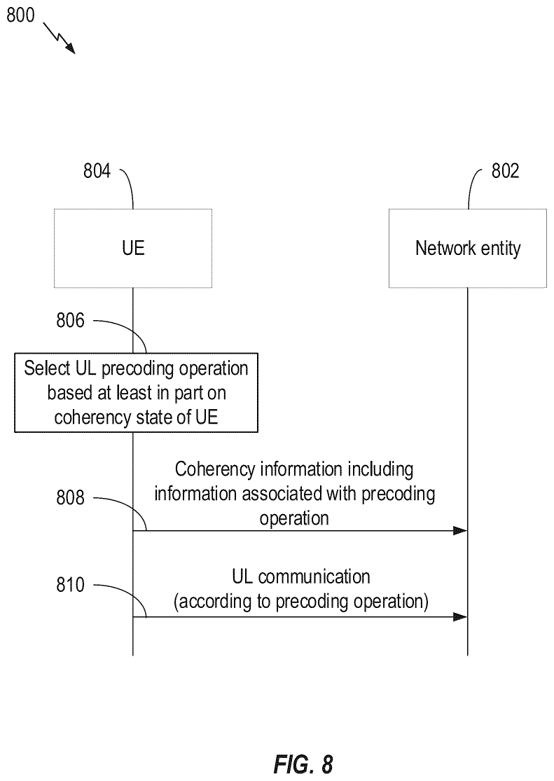

FIG. 8 depicts a process flow 800 for communications in a network between a network entity 802 and a user equipment (UE) 804. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

At reference 806, the UE 804 selects a precoding operation to be applied to an uplink communication. The uplink communication may include, for example, a PUCCH communication or a PUSCH communication. In some aspects, UE 804 selects the precoding operation based at least in part on a coherency state of the UE 804 at a time associated with the uplink communication. The coherency state of the UE 804 may be, for example, a fully coherent state (e.g., a state in which a fixed phase relationship is maintained among all transmit antennas of the UE 804), a partially coherent state (e.g., a state in which phase correlation is maintained for at least some transmit antennas of the UE 804), or a non-coherent state (e.g., a state in which no phase correlation is maintained for transmit antennas of the UE 804).

Thus, in some aspects, if the UE 804 identifies the coherency state of the UE as a fully coherent state, then then the UE 804 selects the precoding operation as a fully coherent precoding. That is, the UE 804 may select fully coherent precoding based at least in part on the UE 804 being in a fully coherent state at a time at which the uplink communication is to be transmitted. Similarly, in some aspects, if the UE 804 identifies the coherency state of the UE as a partially coherent state, then then the UE 804 selects the precoding operation as a partially coherent precoding. That is, the UE 804 may select partially coherent precoding based at least in part on the UE 804 being in a partially coherent state at a time at which the uplink communication is to be transmitted. Further, in some aspects, if the UE 804 identifies the coherency state of the UE as a non-coherent state, then then the UE 804 selects the precoding operation as a non-coherent precoding. That is, the UE 804 may select non-coherent precoding based at least in part on the UE 804 being in a non-coherent state at a time at which the uplink communication is to be transmitted.

At 808, the UE 804 transmits coherency information including information associated with the precoding operation. For example, the UE 804 may transmit coherency information that indicates the precoding operation to be applied by the UE 804 in association with transmitting the uplink communication. Therefore, in some aspects, the coherency information indicates whether coherent precoding (e.g., fully coherent precoding or partially coherent precoding) or non-coherent precoding is to be applied by the UE 804 in association with transmitting the uplink communication. In some aspects, the coherency information may be transmitted in one or more control signals.

At 810, the UE 804 transmits the uplink communication according to the precoding operation. For example, if the precoding operation selected by the UE 804 is a fully coherent precoding, then, when transmitting the PUCCH communication, the UE 804 may perform the fully coherent precoding using a fully coherent precoder. In some aspects, the fully coherent precoder may be a precoder that maps the uplink communication to at least two antenna ports of the UE 804 (e.g., when the uplink communication is a multi-port PUCCH communication). In some aspects, the fully coherent precoder may be indicated to the UE 804 by the network entity 802 (e.g., in a precoding configuration or in an uplink grant).

As another example, if the precoding operation selected by the UE 804 is a partially coherent precoding, then, when transmitting the PUCCH communication, the UE 804 may perform the partially coherent precoding using a partially coherent precoder. In some aspects, the partially coherent precoder may be a precoder that maps the uplink communication to at least two antenna ports of the UE 804 (e.g., when the uplink communication is a multi-port PUCCH communication). In some aspects, the partially coherent precoder may be indicated to the UE 804 by the network entity 802 (e.g., in a precoding configuration) or may be determined by the UE 804 (e.g., based at least in part on a fully coherent precoder indicated to the UE 804).

As another example, if the precoding operation selected by the UE 804 is a non-coherent precoding, then, when transmitting the PUCCH communication, the UE 804 may perform the non-coherent precoding using a non-coherent precoder. In some aspects, the non-coherent precoder may be a precoder that maps the uplink communication to at least two antenna ports of the UE 804 (e.g., when the uplink communication is a multi-port PUCCH communication). In some such aspects, the non-coherent may be indicated to the UE 804 (e.g., in a precoding configuration) or may be determined by the UE 804.

In some aspects, the UE 804 may receive, from the network entity 802, a precoding configuration. In some aspects, the precoding configuration may indicate, for example, a fully coherent precoder associated with performing a fully coherent precoding, a partially coherent precoder associated with performing a partially coherent precoding, or a non-coherent precoder associated with performing a non-coherent precoding. That is, in some aspects, the UE 804 may receive a precoding configuration that indicates one or more precoders to be used by the UE 804. In some aspects, the precoding configuration may be communicated in, for example, downlink control information (DCI), a medium access control (MAC) control element (CE), an uplink grant, or the like. In some aspects, the UE 804 may receive the precoding configuration from the network entity 802 prior to selecting the precoding operation.

Note that the process flow illustrated in FIG. 8 is an example of PUCCH transmission using best-effort MIMO, and aspects of the present disclosure may be applied to PUCCH transmission using best-effort MIMO. Note that the process flow illustrated in FIG. 8 is described herein to facilitate an understanding of PUCCH transmission using best-effort MIMO, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

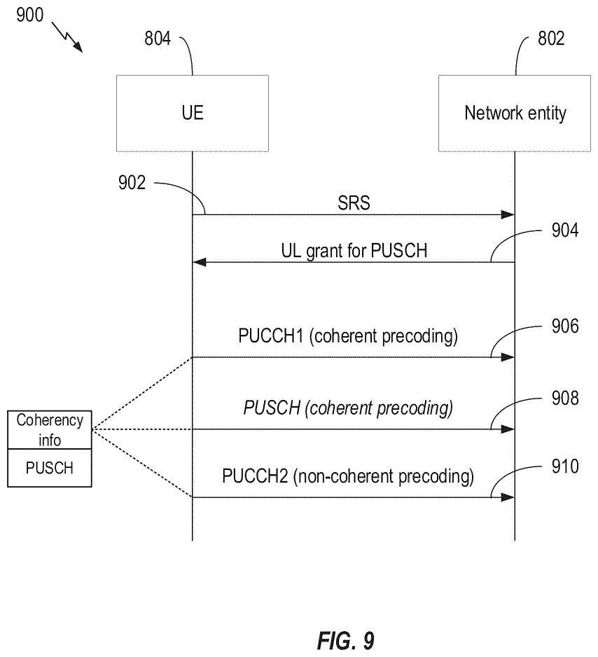

FIG. 9 depicts an example 900 associated with PUCCH transmission using best-effort coherent MIMO according to the techniques and apparatuses depicted and described with respect to FIG. 8. In this example, the UE 804 is to transmit a first PUCCH communication (PUCCH1) and a second PUCCH communication (PUCCH2) for reception by the network entity 502.

In the example 900, at reference 902, the UE 804 transmits an SRS transmission to the network entity 502.

At reference 904, the network entity 502 transmits, to the UE 804, an uplink grant for a PUSCH communication. In some aspects, the uplink grant may be communicated after the SRS transmission, as shown in the example 900. Alternatively, the uplink grant may in some aspects be communicated prior to the SRS transmission by the UE 804 (e.g., the network entity 502 may transmit the uplink grant to the UE 804 prior to the UE 804 transmitting the SRS).

At reference 906, the UE 804 identifies that, at a time of the first PUCCH communication (e.g., during a PUCCH occasion in which the first PUCCH communication (PUCCH1) is to be transmitted), the UE 804 is expected to be in a fully coherent state and, therefore, selects the precoding operation associated with the first PUCCH communication as a fully coherent precoding. As indicated, the UE 804 then transmits the first PUCCH communication accordingly (e.g., using a fully coherent precoder indicated in a precoding configuration received by the UE 804 (not shown)).

At reference 908, the UE 804 identifies that, at a time of the PUSCH communication (e.g., during a time at which the PUSCH communication is to be transmitted), the UE 804 is expected to be in a fully coherent state and, therefore, selects the precoding operation associated with the PUSCH communication as a fully coherent precoding. As indicated, the UE 804 then transmits the PUSCH communication accordingly (e.g., using a fully coherent precoder indicated in the precoding configuration).

At reference 910, the UE 804 identifies that, at a time of the second PUCCH communication (e.g., during a PUCCH occasion in which the second PUCCH (PUCCH2) is to be transmitted), the UE 804 is expected to be in a non-coherent state and, therefore, selects the precoding operation associated with the second PUCCH communication as a non-coherent precoding. As indicated, the UE 804 then transmits the second PUCCH communication accordingly (e.g., using a non-coherent precoder indicated in the precoding configuration).

As further shown in the example 900, the UE 804 may provide coherency information that includes information associated with the precoding operations associated with the first PUCCH communication and the second PUCCH communication. For example, the UE 804 may transmit coherency information that indicates that fully coherent precoding is applied by the UE 804 in association with transmitting the first PUCCH communication and the PUSCH communication, and that the non-coherent precoding was applied in association with transmitting the second PUCCH communication. In this way, the coherency information may indicate whether coherent precoding (e.g., fully coherent precoding or partially coherent precoding) or non-coherent precoding is applied by the UE 804 in association with transmitting a given uplink communication (e.g., so as to enable the UE 804 to successfully decode the uplink communications). In this way, the UE 804 may provide information that indicates whether the UE 804 has used fully coherent precoding, partially coherent precoding, or non-coherent precoding. In some aspects, the coherency information may be communicated in control information via an uplink channel (e.g., in a PUCCH or a PUSCH).

### Example Operations of a User Equipment

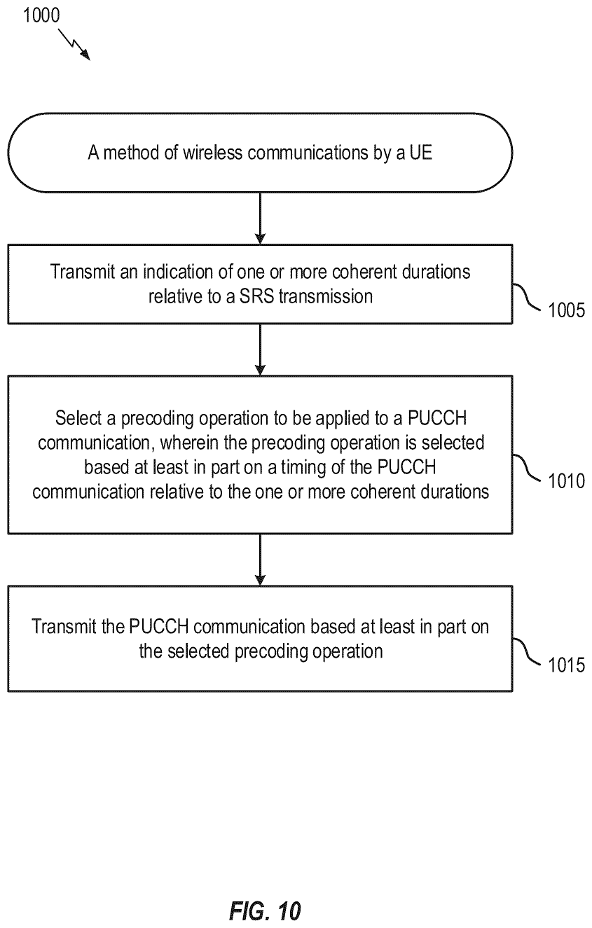

FIG. 10 shows a method 1000 for wireless communications by a UE, such as UE 104 of FIG. 1 or UE 304 of FIG. 3.

Method 1000 begins at block 1005 with transmitting an indication of one or more coherent durations relative to an SRS transmission. For example, a UE 504 may transmit an indication of one or more coherent durations relative to an SRS transmission, as depicted and described with respect to reference 506 of FIG. 5.

Method 1000 then proceeds to block 1010 with selecting a precoding operation to be applied to a PUCCH communication, wherein the precoding operation is selected based at least in part on a timing of the PUCCH communication relative to the one or more coherent durations. For example, the UE 504 may select a precoding operation to be applied to a PUCCH communication, as depicted and described above with respect to reference 508 of FIG. 5.

Method 1000 then proceeds to block 1015 with transmitting the PUCCH communication based at least in part on the selected precoding operation. For example, the UE 504 may transmit the PUCCH communication based at least in part on the selected precoding operation, as depicted and described with respect to reference 510 of FIG. 5.

In some aspects, method 1000 further includes determining whether a frequency domain resource allocation of the PUCCH communication is included in a bandwidth of the SRS transmission, wherein block 1010 includes selecting the precoding operation based at least in part on whether the frequency domain resource allocation of the PUCCH communication is included in the bandwidth of the SRS transmission.

In some aspects, method 1000 further includes receiving an uplink grant scheduling a PUSCH communication within at least one coherent duration of the one or more coherent durations, and determining whether a frequency domain resource allocation of the PUCCH communication is included in a bandwidth of the PUSCH communication, wherein block 1010 includes selecting the precoding operation based at least in part on whether the frequency domain resource allocation of the PUCCH communication is included in the bandwidth of the PUSCH communication.

In some aspects, method 1000 further includes receiving an uplink grant scheduling a PUSCH communication within at least one coherent duration of the one or more coherent durations, and determining whether an amount of time between the uplink grant and a PUCCH occasion, associated with the PUCCH communication, satisfies a threshold, wherein block 1010 includes selecting the precoding operation based at least in part on whether the amount of time satisfies the threshold.

In some aspects, method 1000 further includes determining that a PUCCH occasion associated with the PUCCH communication is within a fully coherent duration of the one or more coherent durations, wherein block 1010 includes selecting the precoding operation as a fully coherent precoding based at least in part on the PUCCH occasion being within the fully coherent duration.

In some aspects, block 1015 includes performing the fully coherent precoding using a fully coherent precoder that maps the PUCCH communication to at least two antenna ports of the UE.

In some aspects, method 1000 further includes receiving an uplink grant scheduling a PUSCH communication within the fully coherent duration, wherein the uplink grant indicates the fully coherent precoder.

In some aspects, method 1000 further includes determining that a PUCCH occasion associated with the PUCCH communication is outside of a fully coherent duration of the one or more coherent durations and within a partially coherent duration of the one or more coherent durations, wherein block 1010 includes selecting the precoding operation as a partially coherent precoding based at least in part on the PUCCH occasion being outside of the fully coherent duration and within the partially coherent duration.

In some aspects, block 1015 includes performing the partially coherent precoding using a partially coherent precoder that maps the PUCCH communication to at least two antenna ports of the UE.

In some aspects, method 1000 further includes determining that a PUCCH occasion associated with the PUCCH communication is outside of the one or more coherent durations, wherein block 1010 includes selecting the precoding operation as a non-coherent precoding based at least in part on the PUCCH occasion being outside of the one or more coherent durations.

In some aspects, block 1015 includes performing the non-coherent precoding using a non-coherent precoder that maps the PUCCH communication to at least two antenna ports of the UE.

In some aspects, a first coherent duration of the one or more coherent durations is associated with a first quantity of antennas and a second coherent duration of the one or more coherent durations is associated with a second quantity of antennas.

In some aspects, method 1000 further includes receiving, from a network entity, an enablement indication, wherein the enablement indication indicates whether coherent precoding is enabled for PUCCH communications transmitted in PUCCH occasions that are within at least one of the one or more coherent durations.

In some aspects, method 1000 further includes determining whether coherent precoding is enabled for the PUCCH communications, in accordance with the enablement indication, based at least in part on one or more PUCCH characteristics.

In some aspects, the one or more PUCCH characteristics include at least one of a format, a payload size, a symbol lasting length, a starting symbol index, an RB allocation index, a starting RB index, or whether frequency hopping is enabled.

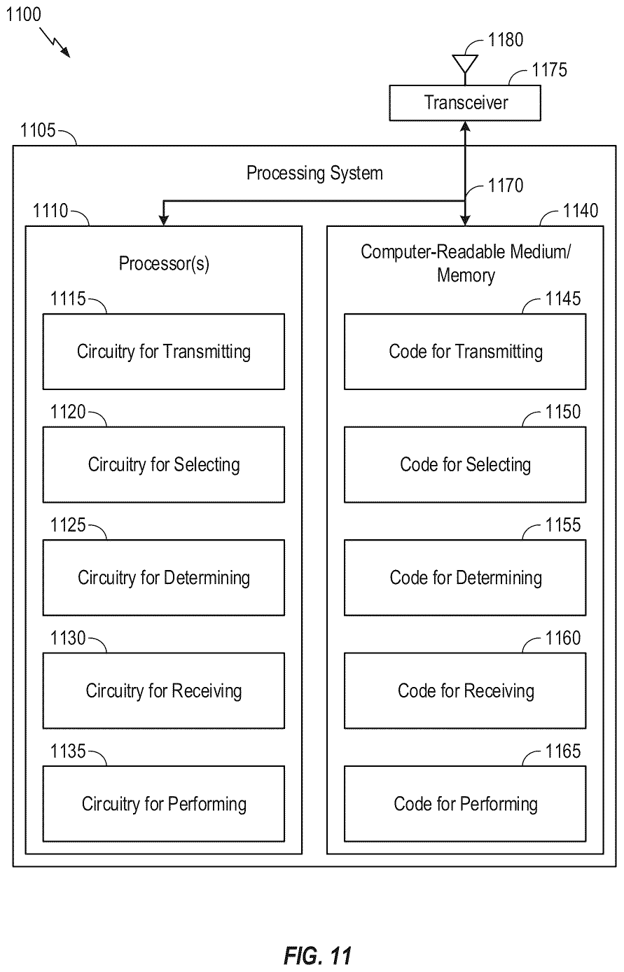

In some aspects, method 1000, or any aspect related to it, may be performed by an apparatus, such as communications device 1100 of FIG. 11, which includes various components operable, configured, or adapted to perform the method 1000. Communications device 1100 is described below in further detail.

In some aspects, the techniques for PUCCH transmission using best-effort coherent MIMO depicted and described with respect to the method 1000 enable improved wireless communications performance, such as increased PUCCH reliability. The increased PUCCH reliability may be attributable to the method 1000, for example, due to enabling the achievement of coherent combining gain for (at least a portion of) PUCCH occasions of some PUCCH transmissions (e.g., multi-port PUCCH transmissions). For example, the method 1000 may enable a UE to apply fully coherent precoding when possible, meaning that coherent gain can be achieved for at least some PUCCH transmissions so as to increase PUCCH reliability.

Note that FIG. 10 is just one example of a method, and other methods including fewer, additional, or alternative operations are possible consistent with this disclosure.

### Example Communications Device

FIG. 11 depicts aspects of an example communications device 1100 configured for wireless communications. In some aspects, communications device 1100 is a user equipment, such as UE 104 described above with respect to FIG. 1 or UE 304 described with respect to FIG. 3.

The communications device 1100 includes a processing system 1105 coupled to a transceiver 1175 (e.g., a transmitter and/or a receiver). The transceiver 1175 is configured to transmit and receive signals for the communications device 1100 via an antenna 1180, such as the various signals as described herein. The processing system 1105 may be configured to perform processing functions for the communications device 1100, including processing signals received and/or to be transmitted by the communications device 1100.

The processing system 1105 includes one or more processors 1110 and a computer-readable medium/memory 1140. In various aspects, the one or more processors 1110 may be representative of the one or more processors 318 described with respect to FIG. 3. The one or more processors 1110 are coupled to a computer-readable medium/memory 1140 via a bus 1170. In some aspects, the computer-readable medium/memory 1140 may be representative of the one or more memories 320 described with respect to FIG. 3. The computer-readable medium/memory 1140 is a non-transitory computer-readable medium/memory. In certain aspects, the computer-readable medium/memory 1140 is configured to store instructions (e.g., computer-executable code), that when executed by the one or more processors 1110, cause the one or more processors 1110 to perform the method 1000 described with respect to FIG. 10, or any aspect related to it, including any operations described in relation to FIG. 10. Note that reference to a processor performing a function of communications device 1100 may include one or more processors performing that function of communications device 1100, such as in a distributed fashion.

In the depicted example, computer-readable medium/memory 1140 stores code (e.g., executable instructions), including code for transmitting 1145, code for selecting 1150, code for determining 1155, code for receiving 1160, and code for performing 1165. Processing of the code 1145-1165 may enable and cause the communications device 1100 to perform the method 1000 described with respect to FIG. 10, or any aspect related to it. For instance, in some aspects, code for transmitting 1145 includes code for transmitting an indication of one or more coherent durations relative to an SRS transmission. In some aspects, code for selecting 1150 includes code for selecting a precoding operation to be applied to a PUCCH communication, wherein the precoding operation is selected based at least in part on a timing of the PUCCH communication relative to the one or more coherent durations. In some aspects, code for transmitting 1145 includes code for transmitting the PUCCH communication based at least in part on the selected precoding operation.

The one or more processors 1110 include circuitry configured to implement (e.g., execute) the code stored in the computer-readable medium/memory 1140, including circuitry for transmitting 1115, circuitry for selecting 1120, circuitry for determining 1125, circuitry for receiving 1130, and circuitry for performing 1135. Processing with circuitry 1115-1135 may enable and cause the communications device 1100 to perform the method 1000 described with respect to FIG. 10, or any aspect related to it. For instance, in some aspects, circuitry for transmitting 1115 includes circuitry for transmitting an indication of one or more coherent durations relative to an SRS transmission. In some aspects, circuitry for selecting 1120 includes circuitry for selecting a precoding operation to be applied to a PUCCH communication, wherein the precoding operation is selected based at least in part on a timing of the PUCCH communication relative to the one or more coherent durations. In some aspects, circuitry for transmitting 1115 includes circuitry for transmitting the PUCCH communication based at least in part on the selected precoding operation.

More generally, means for communicating, transmitting, sending or outputting for transmission may include the one or more transceivers 324, one or more antenna 322 and/or processing system 316 of the UE 304 illustrated in FIG. 3, transceiver 1175 and/or antenna 1180 of the communications device 1100 in FIG. 11, and/or one or more processors 1110 of the communications device 1100 in FIG. 11. Means for communicating, receiving or obtaining may include the one or more transceivers 324, one or more antennas 322, and/or processing system 316 of the UE 304 illustrated in FIG. 3, transceiver 1175 and/or antenna 1180 of the communications device 1100 in FIG. 11, and/or one or more processors 1110 of the communications device 1100 in FIG. 11.

### Example Operations of a User Equipment

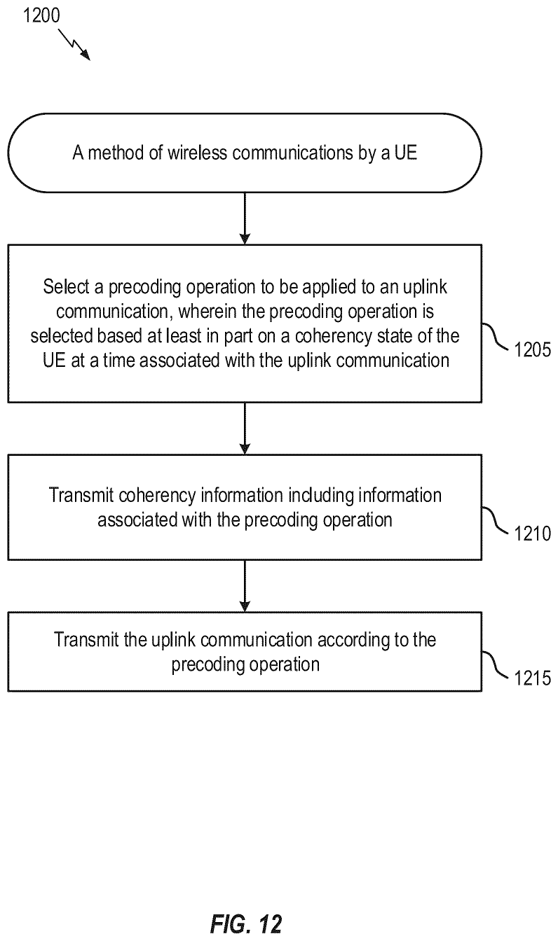

FIG. 12 shows a method 1200 for wireless communications by a UE, such as UE 104 of FIG. 1 or UE 304 of FIG. 3.

Method 1200 begins at block 1205 with selecting a precoding operation to be applied to an uplink communication, wherein the precoding operation is selected based at least in part on a coherency state of the UE at a time associated with the uplink communication. For example, a UE 804 may select a precoding operation to be applied to an uplink communication, as depicted and described with respect to reference 806 of FIG. 8.

Method 1200 then proceeds to block 1210 with transmitting coherency information including information associated with the precoding operation. For example, the UE 804 may transmit coherency information including information associated with the precoding operation, as depicted and described with respect to reference 808 of FIG. 8

Method 1200 then proceeds to block 1215 with transmitting the uplink communication according to the precoding operation. For example, the UE 804 may transmit the uplink communication according to the precoding operation, as depicted and described with respect to reference 810 of FIG. 8.

In some aspects, method 1200 further includes identifying the coherency state of the UE as a fully coherent state, wherein block 1205 includes selecting the precoding operation as a fully coherent precoding based at least in part on identifying the coherency state of the UE as the fully coherent state.

In some aspects, block 1215 includes performing the fully coherent precoding using a fully coherent precoder that maps the uplink communication to at least two antenna ports of the UE.

In some aspects, the coherency information indicates that that the precoding operation comprises the fully coherent precoding.

In some aspects, method 1200 further includes identifying the coherency state of the UE as a partially coherent state, wherein block 1205 includes selecting the precoding operation as a partially coherent precoding based at least in part on identifying the coherency state of the UE as the partially coherent state.

In some aspects, block 1215 includes performing the partially coherent precoding using a partially coherent precoder that maps the uplink communication to at least two antenna ports of the UE.

In some aspects, the coherency information indicates that that the precoding operation comprises the partially coherent precoding.

In some aspects, method 1200 further includes identifying the coherency state of the UE as a non-coherent state, wherein block 1205 includes selecting the precoding operation as a non-coherent precoding based at least in part on identifying the coherency state of the UE as the non-coherent state.

In some aspects, block 1215 includes performing the non-coherent precoding using a non-coherent precoder that maps the uplink communication to at least two antenna ports of the UE.

In some aspects, the coherency information indicates that that the precoding operation comprises the non-coherent precoding.

In some aspects, the coherency information is transmitted in a control signal.

In some aspects, method 1200 further includes receiving a precoding configuration indicating at least one of a fully coherent precoder associated with performing a fully coherent precoding, a partially coherent precoder associated with performing a partially coherent precoding, or a non-coherent precoder associated with performing a non-coherent precoding, wherein the precoding configuration is received prior to selecting the precoding operation.

In some aspects, the precoding configuration is received in at least one of downlink control information or a medium access control control element.

In some aspects, the uplink communication comprises at least one of a physical uplink shared channel communication or a physical uplink control channel communication.

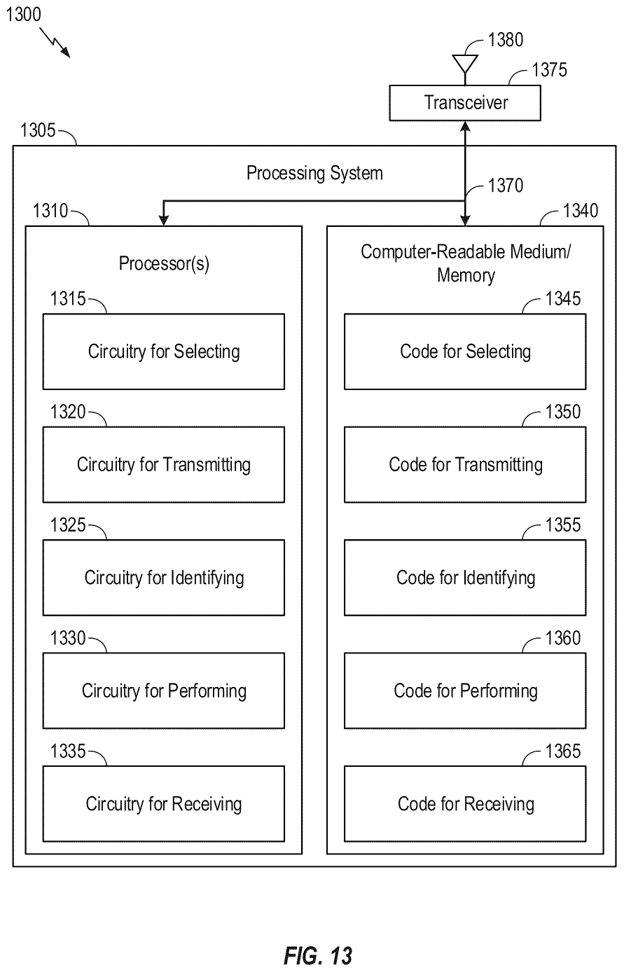

In some aspects, method 1200, or any aspect related to it, may be performed by an apparatus, such as communications device 1300 of FIG. 13, which includes various components operable, configured, or adapted to perform the method 1200. Communications device 1300 is described below in further detail.

In some aspects, the techniques for PUCCH transmission using best-effort coherent MIMO depicted and described with respect to the method 1200 enable improved wireless communications performance, such as increased PUCCH reliability. The increased PUCCH reliability may be attributable to the method 1000, for example, due to enabling the achievement of coherent combining gain for (at least a portion of) PUCCH occasions of some PUCCH transmissions (e.g., multi-port PUCCH transmissions). For example, the method 1200 may enable a UE to apply fully coherent precoding when possible, meaning that coherent gain can be achieved for at least some PUCCH transmissions so as to increase PUCCH reliability.

Note that FIG. 12 is just one example of a method, and other methods including fewer, additional, or alternative operations are possible consistent with this disclosure.

### Example Communications Device

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1375 (e.g., a transmitter and/or a receiver). The transceiver 1375 is configured to transmit and receive signals for the communications device 1300 via an antenna 1380, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1340. In various aspects, the one or more processors 1310 may be representative of the one or more processors 318 described with respect to FIG. 3. The one or more processors 1310 are coupled to a computer-readable medium/memory 1340 via a bus 1370. In some aspects, the computer-readable medium/memory 1340 may be representative of the one or more memories 320 described with respect to FIG. 3. The computer-readable medium/memory 1340 is a non-transitory computer-readable medium/memory. In certain aspects, the computer-readable medium/memory 1340 is configured to store instructions (e.g., computer-executable code), that when executed by the one or more processors 1310, cause the one or more processors 1310 to perform the method 1200 described with respect to FIG. 12, or any aspect related to it, including any operations described in relation to FIG. 12. Note that reference to a processor performing a function of communications device 1300 may include one or more processors performing that function of communications device 1300, such as in a distributed fashion.

In the depicted example, computer-readable medium/memory 1340 stores code (e.g., executable instructions), including code for selecting 1345, code for transmitting 1350, code for identifying 1355, code for performing 1360, and code for receiving 1365. Processing of the code 1345-1365 may enable and cause the communications device 1300 to perform the method 1200 described with respect to FIG. 12, or any aspect related to it. For instance, in some aspects, code for selecting 1345 includes code for selecting a precoding operation to be applied to an uplink communication, wherein the precoding operation is selected based at least in part on a coherency state of the UE at a time associated with the uplink communication. In some aspects, code for transmitting 1350 includes code for transmitting coherency information including information associated with the precoding operation. In some aspects, code for transmitting 1350 includes code for transmitting the uplink communication according to the precoding operation.

The one or more processors 1310 include circuitry configured to implement (e.g., execute) the code stored in the computer-readable medium/memory 1340, including circuitry for selecting 1315, circuitry for transmitting 1320, circuitry for identifying 1325, circuitry for performing 1330, and circuitry for receiving 1335. Processing with circuitry 1315-1335 may enable and cause the communications device 1300 to perform the method 1200 described with respect to FIG. 12, or any aspect related to it. For instance, in some aspects, circuitry for selecting 1315 includes circuitry for selecting a precoding operation to be applied to an uplink communication, wherein the precoding operation is selected based at least in part on a coherency state of the UE at a time associated with the uplink communication. In some aspects, circuitry for transmitting 1320 includes circuitry for transmitting coherency information including information associated with the precoding operation. In some aspects, circuitry for transmitting 1320 includes circuitry for transmitting the uplink communication according to the precoding operation.

More generally, means for communicating, transmitting, sending or outputting for transmission may include the one or more transceivers 324, one or more antenna 322 and/or processing system 316 of the UE 304 illustrated in FIG. 3, transceiver 1375 and/or antenna 1380 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1375 and/or antenna 1380 of the communications device 1300 in FIG. 13, and/or one or more processors 1310 of the communications device 1300 in FIG. 13.

### Example Clauses

Implementation examples are described in the following numbered clauses:
Clause 1: A method of wireless communications by a UE, comprising: transmitting an indication of one or more coherent durations relative to an SRS transmission; selecting a precoding operation to be applied to a PUCCH communication, wherein the precoding operation is selected based at least in part on a timing of the PUCCH communication relative to the one or more coherent durations; and transmitting the PUCCH communication based at least in part on the selected precoding operation.
Clause 2: The method of Clause 1, further comprising: determining whether a frequency domain resource allocation of the PUCCH communication is included in a bandwidth of the SRS transmission, wherein selecting the precoding operation comprises selecting the precoding operation based at least in part on whether the frequency domain resource allocation of the PUCCH communication is included in the bandwidth of the SRS transmission.
Clause 3: The method of any one of Clauses 1-2, further comprising: receiving an uplink grant scheduling a PUSCH communication within at least one coherent duration of the one or more coherent durations, and determining whether a frequency domain resource allocation of the PUCCH communication is included in a bandwidth of the PUSCH communication, wherein selecting the precoding operation comprises selecting the precoding operation based at least in part on whether the frequency domain resource allocation of the PUCCH communication is included in the bandwidth of the PUSCH communication.
Clause 4: The method of any one of Clauses 1-3, further comprising: receiving an uplink grant scheduling a PUSCH communication within at least one coherent duration of the one or more coherent durations, and determining whether an amount of time between the uplink grant and a PUCCH occasion, associated with the PUCCH communication, satisfies a threshold, wherein selecting the precoding operation comprises selecting the precoding operation based at least in part on whether the amount of time satisfies the threshold.
Clause 5: The method of any one of Clauses 1-4, further comprising: determining that a PUCCH occasion associated with the PUCCH communication is within a fully coherent duration of the one or more coherent durations, wherein selecting the precoding operation comprises selecting the precoding operation as a fully coherent precoding based at least in part on the PUCCH occasion being within the fully coherent duration.
Clause 6: The method of Clause 5, wherein transmitting the PUCCH communication comprises performing the fully coherent precoding using a fully coherent precoder that maps the PUCCH communication to at least two antenna ports of the UE.
Clause 7: The method of Clause 6, further comprising: receiving an uplink grant scheduling a PUSCH communication within the fully coherent duration, wherein the uplink grant indicates the fully coherent precoder.
Clause 8: The method of any one of Clauses 1-7, further comprising: determining that a PUCCH occasion associated with the PUCCH communication is outside of a fully coherent duration of the one or more coherent durations and within a partially coherent duration of the one or more coherent durations, wherein selecting the precoding operation comprises selecting the precoding operation as a partially coherent precoding based at least in part on the PUCCH occasion being outside of the fully coherent duration and within the partially coherent duration.
Clause 9: The method of Clause 8, wherein transmitting the PUCCH communication comprises performing the partially coherent precoding using a partially coherent precoder that maps the PUCCH communication to at least two antenna ports of the UE.
Clause 10: The method of any one of Clauses 1-9, further comprising: determining that a PUCCH occasion associated with the PUCCH communication is outside of the one or more coherent durations, wherein selecting the precoding operation comprises selecting the precoding operation as a non-coherent precoding based at least in part on the PUCCH occasion being outside of the one or more coherent durations.
Clause 11: The method of Clause 10, wherein transmitting the PUCCH communication comprises performing the non-coherent precoding using a non-coherent precoder that maps the PUCCH communication to at least two antenna ports of the UE.
Clause 12: The method of any one of Clauses 1-11, wherein a first coherent duration of the one or more coherent durations is associated with a first quantity of antennas and a second coherent duration of the one or more coherent durations is associated with a second quantity of antennas.
Clause 13: The method of any one of Clauses 1-12, further comprising receiving, from a network entity, an enablement indication, wherein the enablement indication indicates whether coherent precoding is enabled for PUCCH communications transmitted in PUCCH occasions that are within at least one of the one or more coherent durations.
Clause 14: The method of Clause 13, further comprising determining whether coherent precoding is enabled for the PUCCH communications, in accordance with the enablement indication, based at least in part on one or more PUCCH characteristics.
Clause 15: The method of Clause 14, wherein the one or more PUCCH characteristics include at least one of a format, a payload size, a symbol lasting length, a starting symbol index, an RB allocation index, a starting RB index, or whether frequency hopping is enabled.
Clause 16: A method of wireless communications by a UE, comprising: selecting a precoding operation to be applied to an uplink communication, wherein the precoding operation is selected based at least in part on a coherency state of the UE at a time associated with the uplink communication; transmitting coherency information including information associated with the precoding operation; and transmitting the uplink communication according to the precoding operation.
Clause 17: The method of Clause 16, further comprising: identifying the coherency state of the UE as a fully coherent state, wherein selecting the precoding operation comprises selecting the precoding operation as a fully coherent precoding based at least in part on identifying the coherency state of the UE as the fully coherent state.
Clause 18: The method of Clause 17, wherein transmitting the uplink communication comprises performing the fully coherent precoding using a fully coherent precoder that maps the uplink communication to at least two antenna ports of the UE.
Clause 19: The method of Clause 17, wherein the coherency information indicates that that the precoding operation comprises the fully coherent precoding.
Clause 20: The method of any one of Clauses 16-19, further comprising: identifying the coherency state of the UE as a partially coherent state, wherein selecting the precoding operation comprises selecting the precoding operation as a partially coherent precoding based at least in part on identifying the coherency state of the UE as the partially coherent state.
Clause 21: The method of Clause 20, wherein transmitting the uplink communication comprises performing the partially coherent precoding using a partially coherent precoder that maps the uplink communication to at least two antenna ports of the UE.
Clause 22: The method of Clause 20, wherein the coherency information indicates that that the precoding operation comprises the partially coherent precoding.
Clause 23: The method of any one of Clauses 16-22, further comprising: identifying the coherency state of the UE as a non-coherent state, wherein selecting the precoding operation comprises selecting the precoding operation as a non-coherent precoding based at least in part on identifying the coherency state of the UE as the non-coherent state.
Clause 24: The method of Clause 23, wherein transmitting the uplink communication comprises performing the non-coherent precoding using a non-coherent precoder that maps the uplink communication to at least two antenna ports of the UE.
Clause 25: The method of Clause 23, wherein the coherency information indicates that that the precoding operation comprises the non-coherent precoding.
Clause 26: The method of any one of Clauses 16-25, wherein the coherency information is transmitted in a control signal.
Clause 27: The method of any one of Clauses 16-26, further comprising: receiving a precoding configuration indicating at least one of a fully coherent precoder associated with performing a fully coherent precoding, a partially coherent precoder associated with performing a partially coherent precoding, or a non-coherent precoder associated with performing a non-coherent precoding, wherein the precoding configuration is received prior to selecting the precoding operation.
Clause 28: The method of Clause 27, wherein the precoding configuration is received in at least one of downlink control information or a medium access control control element.
Clause 29: The method of any one of Clauses 16-28, wherein the uplink communication comprises at least one of a physical uplink shared channel communication or a physical uplink control channel communication.
Clause 30: One or more apparatuses, comprising: one or more memories comprising executable instructions; and one or more processors configured to execute the executable instructions and cause the one or more apparatuses to perform a method in accordance with any one of Clauses 1-29.
Clause 31: One or more apparatuses configured for wireless communications, comprising: one or more memories; and one or more processors, coupled to the one or more memories, configured to cause the one or more apparatuses to perform a method in accordance with any one of Clauses 1-29.
Clause 32: One or more apparatuses configured for wireless communications, comprising: one or more memories; and one or more processors, coupled to the one or more memories, configured to perform a method in accordance with any one of Clauses 1-29.
Clause 33: One or more apparatuses, comprising means for performing a method in accordance with any one of Clauses 1-29.
Clause 34: One or more non-transitory computer-readable media comprising executable instructions that, when executed by one or more processors of one or more apparatuses, cause the one or more apparatuses to perform a method in accordance with any one of Clauses 1-29.
Clause 35: One or more computer program products embodied on one or more computer-readable storage media comprising code for performing a method in accordance with any one of Clauses 1-29.
Clause 36: One or more apparatuses configured for wireless communications, comprising: a processing system that includes one or more processors and one or more memories coupled with the one or more processors, the processing system configured to cause the one or more apparatuses to perform a method in accordance with any one of Clauses 1-29.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
transmit an indication of one or more coherent durations relative to a sounding reference signal (SRS) transmission;
select a precoding operation to be applied to a PUCCH communication, wherein the precoding operation is selected based at least in part on a timing of the PUCCH communication relative to the one or more coherent durations; and
transmit the PUCCH communication based at least in part on the selected precoding operation.

2. The apparatus of claim 1, wherein the processing system is further configured to cause the UE to:
determine whether a frequency domain resource allocation of the PUCCH communication is included in a bandwidth of the SRS transmission,
wherein selecting the precoding operation comprises selecting the precoding operation based at least in part on whether the frequency domain resource allocation of the PUCCH communication is included in the bandwidth of the SRS transmission.

3. The apparatus of claim 1, wherein the processing system is further configured to cause the UE to:
receive an uplink grant scheduling a physical uplink shared channel (PUSCH) communication within at least one coherent duration of the one or more coherent durations, and
determine whether a frequency domain resource allocation of the PUCCH communication is included in a bandwidth of the PUSCH communication,
wherein to cause the UE to select the precoding operation, the processing system is configured to cause the UE to select the precoding operation based at least in part on whether the frequency domain resource allocation of the PUCCH communication is included in the bandwidth of the PUSCH communication.

4. The apparatus of claim 1, wherein the processing system is further configured to cause the UE to:
receive an uplink grant scheduling a physical uplink shared channel (PUSCH) communication within at least one coherent duration of the one or more coherent durations, and
determine whether an amount of time between the uplink grant and a PUCCH occasion, associated with the PUCCH communication, satisfies a threshold,
wherein to cause the UE to select the precoding operation, the processing system is configured to cause the UE to select the precoding operation based at least in part on whether the amount of time satisfies the threshold.

5. The apparatus of claim 1, wherein the processing system is further configured to cause the UE to:
determine that a PUCCH occasion associated with the PUCCH communication is within a fully coherent duration of the one or more coherent durations,
wherein to cause the UE to select the precoding operation, the processing system is configured to cause the UE to select the precoding operation as a fully coherent precoding based at least in part on the PUCCH occasion being within the fully coherent duration.

6. The apparatus of claim 5, wherein to cause the UE to transmit the PUCCH communication, the processing system is configured to cause the UE to perform the fully coherent precoding using a fully coherent precoder that maps the PUCCH communication to at least two antenna ports of the UE.

7. The apparatus of claim 6, wherein the processing system is further configured to cause the UE to:
receive an uplink grant scheduling a physical uplink shared channel (PUSCH) communication within the fully coherent duration,
wherein the uplink grant indicates the fully coherent precoder.

8. The apparatus of claim 1, wherein the processing system is further configured to cause the UE to:
determine that a PUCCH occasion associated with the PUCCH communication is outside of a fully coherent duration of the one or more coherent durations and within a partially coherent duration of the one or more coherent durations,
wherein to cause the UE to select the precoding operation, the processing system is configured to cause the UE to select the precoding operation as a partially coherent precoding based at least in part on the PUCCH occasion being outside of the fully coherent duration and within the partially coherent duration.

9. The apparatus of claim 8, wherein to cause the UE to transmit the PUCCH communication, the processing system is configured to cause the UE to perform the partially coherent precoding using a partially coherent precoder that maps the PUCCH communication to at least two antenna ports of the UE.

10. The apparatus of claim 1, wherein the processing system is further configured to cause the UE to:
determine that a PUCCH occasion associated with the PUCCH communication is outside of the one or more coherent durations,
wherein to cause the UE to select the precoding operation, the processing system is configured to cause the UE to select the precoding operation as a non-coherent precoding based at least in part on the PUCCH occasion being outside of the one or more coherent durations.

11. The apparatus of claim 10, wherein to cause the UE to transmit the PUCCH communication, the processing system is configured to cause the UE to perform the non-coherent precoding using a non-coherent precoder that maps the PUCCH communication to at least two antenna ports of the UE.

12. The apparatus of claim 1, wherein a first coherent duration of the one or more coherent durations is associated with a first quantity of antennas and a second coherent duration of the one or more coherent durations is associated with a second quantity of antennas.

13. The apparatus of claim 1, wherein the processing system is further configured to cause the UE to receive, from a network entity, an enablement indication, wherein the enablement indication indicates whether coherent precoding is enabled for PUCCH communications transmitted in PUCCH occasions that are within at least one of the one or more coherent durations.

14. The apparatus of claim 13, wherein the processing system is further configured to cause the UE to determine whether coherent precoding is enabled for the PUCCH communications, in accordance with the enablement indication, based at least in part on one or more PUCCH characteristics.

15. The apparatus of claim 14, wherein the one or more PUCCH characteristics include at least one of a format, a payload size, a symbol lasting length, a starting symbol index, a resource block (RB) allocation index, a starting RB index, or whether frequency hopping is enabled.

16. A method of wireless communications by a user equipment (UE), comprising:
transmitting an indication of one or more coherent durations relative to a sounding reference signal (SRS) transmission;
selecting a precoding operation to be applied to a PUCCH communication, wherein the precoding operation is selected based at least in part on a timing of the PUCCH communication relative to the one or more coherent durations; and
transmitting the PUCCH communication based at least in part on the selected precoding operation.

17. The method of claim 16, further comprising:
determining whether a frequency domain resource allocation of the PUCCH communication is included in a bandwidth of the SRS transmission,
wherein selecting the precoding operation comprises selecting the precoding operation based at least in part on whether the frequency domain resource allocation of the PUCCH communication is included in the bandwidth of the SRS transmission.

18. The method of claim 16, further comprising:
receiving an uplink grant scheduling a physical uplink shared channel (PUSCH) communication within at least one coherent duration of the one or more coherent durations, and
determining whether a frequency domain resource allocation of the PUCCH communication is included in a bandwidth of the PUSCH communication,
wherein selecting the precoding operation comprises selecting the precoding operation based at least in part on whether the frequency domain resource allocation of the PUCCH communication is included in the bandwidth of the PUSCH communication.

19. The method of claim 16, further comprising:
receiving an uplink grant scheduling a physical uplink shared channel (PUSCH) communication within at least one coherent duration of the one or more coherent durations, and
determining whether an amount of time between the uplink grant and a PUCCH occasion, associated with the PUCCH communication, satisfies a threshold,
wherein selecting the precoding operation comprises selecting the precoding operation based at least in part on whether the amount of time satisfies the threshold.

20. An apparatus for wireless communication comprising:
means for transmitting an indication of one or more coherent durations relative to a sounding reference signal (SRS) transmission;
means for selecting a precoding operation to be applied to a PUCCH communication, wherein the precoding operation is selected based at least in part on a timing of the PUCCH communication relative to the one or more coherent durations; and
means for transmitting the PUCCH communication based at least in part on the selected precoding operation.
